(19) United States
(12) Patent Application Publication
(10) Pub. No.: US 2022/0235157 A1
(43) Pub. Date: Jul. 28, 2022

(54) 4-METHYL-1-PENTENE BASED RESIN FOAM AND METHOD FOR PRODUCING SAME

(71) Applicant: DM Novafoam Ltd., Kamitakai-gun, Nagano (JP)

(72) Inventors: Youichirou TANAKA, Kamitakai-gun (JP); Yasuyoshi KIMURA, Kamitakai-gun (JP); Takayuki YAGI, Kamitakai-gun (JP)

(73) Assignee: DM Novafoam Ltd., Kamitakai-gun, Nagano (JP)

(21) Appl. No.: 17/616,514

(22) PCT Filed: Jun. 26, 2020
(86) PCT No.: PCT/JP2020/025128

§ 371 Date: Dec. 3, 2021

(30) Foreign Application Priority Data
Jul. 8, 2019 (JP) 2019-127141

(51) Int. Cl. C08F 210/14; C08J 9/14

(52) U.S. Cl. CPC C08F 210/14; C08J 9/141; C08F 2800/10; C08J 2205/05; C08J 2201/03; C08J 2203/14; C08J 2323/20

(57) ABSTRACT

4-methyl-1-pentene based resin foam containing a 4-methyl-1-pentene based resin, and having an expansion ratio of 3 times or more is prepared. When measured in a decalin solvent at 135° C., an intrinsic viscosity [η] of the 4-methyl-1-pentene based resin may be 0.5 to 5 dl/g. The 4-methyl-1-pentene based resin may have a glass transition temperature of 0° C. to 80° C. The 4-methyl-1-pentene based resin may have a melting point. The 4-methyl-1-pentene based resin may be a 4-methyl-1-pentene/C₂₋₂₀α-olefin copolymer (in particular, 4-methyl-1-pentene/C₂₋₄α-olefin copolymer). The expansion ratio of the 4-methyl-1-pentene based resin foam may be 10 times or greater.

### TECHNICAL FIELD

The present disclosure relates to a foam including a 4-methyl-1-pentene based resin and also relates to a method for producing the same.

### BACKGROUND ART

4-methyl-1-pentene based resins are used in various fields such as food industry, medicine, electronic information, home electronics, laboratory instruments, and stationeries etc., as those resins have excellent heat resistance, as well as light weight, transparency, gas permeability, and chemical resistance.

WO 2011/055803 (Patent Document 1) discloses a molded article including a composition containing a 4-methyl-1-pentene copolymer having from 5 to 95 mol % of a structural unit derived from 4-methyl-1-pentene, from 5 to 95 mol % of a structural unit derived from at least one kind of α-olefin selected from α-olefins having from 2 to 20 carbon atoms excluding 4-methyl-1-pentene, and from 0 to 10 mol % of a structural unit derived from a non-conjugated polyene. Examples of the molded articles include sheets, films, pipes, tubes, bottles, fibers, tapes, hollow molded articles, laminates, foams, and the like. In Examples, a 4-methyl-1-pentene/α-olefin copolymer was kneaded with another resin or process oil to produce a press sheet.

JP 2014-208797 A (Patent Document 2) discloses a molded article including a 4-methyl-1-pentene copolymer containing from 80 to 100 mol % of a structural unit derived from 4-methyl-1-pentene and from 0 to 20 mol % of a structural unit derived from at least one kind of α-olefins having from 2 to 20 carbon atoms. Applications of such a molded article are exemplified by health products, care supplies, shock absorbing pads, protectors, sports equipment, sport gears, rackets, balls, conveyances, health appliances, industrial materials, and automotive shock absorbing members are described, and examples of industrial materials include vibration damping pallets, shock absorbing dampers, shock absorbing members for footwear, shock absorbing foams, and shock absorbing films and sheets. In Examples, a film was produced from a 4-methyl-1-pentene-based copolymer.

### CITATION LIST

### Patent Documents

Patent Document 1: WO 2011/055803
Patent Document 2: JP 2014-208797 A

### SUMMARY OF INVENTION

### Technical Problem

However, while foams are disclosed in Patent Documents 1 and 2 as an example of a molded article, foaming of a 4-methyl-1-pentene based resin at a high expansion ratio is difficult, and such foams have not been produced.

Therefore, an object of the present disclosure is to provide a 4-methyl-1-pentene based resin foam having a high expansion ratio and a method for producing the same.

Another object of the present disclosure is to provide a 4-methyl-1-pentene based resin foam having: excellent stress relaxation at a temperature near body temperature; and vibration resistance, and a method for producing the same.

### Solution to Problem

As a result of diligent research to achieve the aforementioned problems, the present inventors have discovered that a 4-methyl-1-pentene based resin can be foamed at a high expansion ratio by foaming the 4-methyl-1-pentene based resin in a specific method, and thus completed the present invention.

That is, the 4-methyl-1-pentene based resin foam according to embodiments of the present disclosure contains a 4-methyl-1-pentene based resin and has an expansion ratio of 3 times or greater (in particular 10 times or greater). When measured in a decalin solvent at 135° C., an intrinsic viscosity [11] of the 4-methyl-1-pentene based resin may be from 0.5 to 5 dl/g. The 4-methyl-1-pentene based resin may have a glass transition temperature of 0° C. to 80° C. The 4-methyl-1-pentene based resin may have a melting point. The 4-methyl-1-pentene based resin may be a 4-methyl-1-pentene/C₂₋₂₀α-olefin copolymer (in particular, 4-methyl-1-pentene/C₂₋₄α-olefin copolymer). The expansion ratio of the 4-methyl-1-pentene based resin foam may be 10 times or greater.

The present disclosure also includes a method for producing a 4-methyl-1-pentene based resin foam by foam-molding a foamable resin composition containing the 4-methyl-1-pentene based resin.

### Advantageous Effects of Invention

In the present disclosure, a 4-methyl-1-pentene based resin foam contains a 4-methyl-1-pentene based resin at a high expansion ratio. Such a foam can improve stress relaxation at a temperature close to body temperature by adjusting the glass transition temperature of the resin, and has vibration resistance.

### DESCRIPTION OF EMBODIMENTS

[4-methyl-1-pentene Based Resin]

The foam according to embodiments of the present disclosure contains a 4-methyl-1-pentene based resin. The 4-methyl-1-pentene based resin may be a homopolymer of 4-methyl-1-pentene, but from the viewpoint of the foaming properties, a copolymer of 4-methyl-1-pentene and other copolymerizable monomer(s) is preferable.

Other copolymerizable monomer(s) include α-olefins, cyclic olefins, ethylenically unsaturated carboxylic acids, (meth)acrylic acid esters, carboxylic acid vinyl esters, aromatic vinyl, conjugated dienes, non-conjugated dienes, and the like.

As the α-olefins, α-olefins other than 4-methyl-1-pentene can be used, and examples thereof include C₂₋₂₀α-linear olefins such as ethylene, 1-propylene, 1-butene, 1-pentene, 1-hexene, 1-octene, 1-decene, 1-dodecene, 1-tetradecene, 1-hexadecene, 1-octadecene, and 1-eicosene; and C₂₋₂₀α-branched chain olefins such as 3-methyl-1-butene, 2-methyl-1-pentene, 3-methyl-1-pentene, 3-ethyl-1-pentene, 4-methyl-1-pentene, 4-methyl-1-hexene, 4, 4-dimethyl-1-hexene, 4,4-dimethyl-1-pentene, 4-ethyl-1-hexene, and 3-ethyl-1-hexene.

Examples of the cyclic olefins include cyclic C₄₋₁₂ cycloolefins such as cyclobutene, cyclopentene, cycloheptene, and cyclooctene; and polycyclic olefins such as 2-norbornene, 5-methyl-2-norbornene, and 5,5-dimethyl-2-norbornene.

As the ethylenically unsaturated carboxylic acids, ethylenically unsaturated carboxylic acids and acid anhydrides thereof can be used, and examples thereof include (meth)acrylic acid, (anhydride)maleic acid, fumaric acid, itaconic acid, citraconic acid, crotonic acid, isocrotonic acid, mesaconic acid, and angenic acid.

Examples of the (meth)acrylic acid ester include (meth)acrylic acid C₁₋₆ alkyl esters such as methyl acrylate, ethyl acrylate, and methyl methacrylate, and glycidyl (meth)acrylate.

Examples of the carboxylic acid vinyl esters include saturated carboxylic acid vinyl esters such as vinyl acetate and vinyl propionate.

Examples of the aromatic vinyls include styrene, vinyl toluene, and α-methylstyrene.

Examples of conjugated dienes include butadiene, isoprene, pentadiene, and 2,3-dimethylbutadiene.

Examples of the non-conjugated dienes include 1,4-hexadiene, 1,6-octadiene, 2-methyl-1,5-hexadiene, 4-methyl-1,4-hexadiene, 5-methyl-1,4-hexadiene, dicyclopentadiene, 5-vinylnorbornene, and 5-ethylidene-2-norbornene.

These other copolymerizable monomers can be used alone or in combination of two or more thereof. Among these, a monomer containing a C₂₋₂₀α-olefin is preferable, a monomer containing a C₂₋₁₀α-olefin is more preferable, a monomer containing C₂₋₆α-olefin is even more preferable, and a monomer containing a C₂₋₄α-olefin is still more preferable. Other copolymerizable monomers may be C₂₋₄α-olefins only, particularly propylene alone.

In the copolymer, a molar ratio of 4-methyl-1-pentene units to other copolymerizable monomer units (in particular C₂₋₄α-olefin) can be selected from the range of former/latter=from 30/70 to 99/1; for example from 50/50 to 97/3, preferably from 60/40 to 95/6, more preferably from 70/30 to 90/10, even more preferably 75/25 to 87/13, and still more preferably from 80/20 to 85/15. If the proportion of other copolymerizable monomers is excessively small, the stress relaxation may be deteriorated, and conversely, if the ratio is excessively large, the foaming properties may be impaired.

The 4-methyl-1-pentene based resin may be crosslinked when used in applications where durability, etc. is required. Known crosslinked 4-methyl-1-pentene resins, for example, a water-crosslinked 4-methyl-1-pentene based resin, a chemical crosslinked 4-methyl-1-pentene based resin, a radiation crosslinked 4-methyl-1-pentene based resin, or an electron beam 4-methyl-1-pentene based resin, may be used. Among these, the water-crosslinked 4-methyl-1-pentene based resin is preferable from the viewpoint of crosslinking properties, productivity, and the like.

The water-crosslinked 4-methyl-1-pentene based resin may be a water-crosslinked product of a 4-methyl-1-pentene based resin having a hydrolytically condensable silyl group (water-crosslinked silyl group) capable of being water-crosslinked, and as a monomer constituting a main chain, it may be a crosslinked polymer obtained by using a monomer having a hydrolytically condensable silyl group, or may be a polymer obtained by graft-polymerizing a monomer having a hydrolytically condensable silyl group in the main chain of the 4-methyl-1-pentene based resin. Examples of the monomer having a silyl group include those monomers disclosed in JP 2016-37551 A and JP 2016-37552 A.

When measured in a decalin solvent at 135° C., the intrinsic viscosity [11] of the 4-methyl-1-pentene based resin can be selected from a range from approximately 0.1 to 10 dl/g, for example, from 0.5 to 5 dl/g, preferably from 0.8 to 4 dl/g, more preferably from 1 to 3.5 dl/g, even more preferably from 1.2 to 3 dl/g, and even still more preferably from 1.3 to 2 dl/g. If the viscosity is excessively small, the mechanical properties of the foam may be impaired, and conversely, if the viscosity is excessively large, the molding processability may be impaired.

In the present specification including claims, measurement can be performed at 135° C. using a decalin solvent, and specifically, measurement can be performed by the method described in Examples described later.

The glass transition temperature (Tg) of the 4-methyl-1-pentene based resin can be selected from a range of approximately −30° C. and to 100° C., and for example, it may be 0° C. to 80° C.; however, for the effect that the stress relaxation can be improved at temperatures near body temperature, it is preferably 10° C. to 55° C., more preferably 15° C. to 50° C., even more preferably 25° C. to 45° C., and even still more preferably 30° C. to 40° C. If the glass transition temperature is excessively small, the mechanical properties of the foam may be impaired, and conversely, if the glass transition temperature is excessively high, the stress relaxation may be impaired.

The 4-methyl-1-pentene based resin may or may not have a melting point (Tm), but it is preferable to have a melting point from the viewpoint of ease of producing a foam with a high expansion ratio. The melting point of the 4-methyl-1-pentene based resin can be selected from a range of approximately 100° C. to 250° C., and for example 105° C. to 200° C., preferably 110° C. to 160° C., more preferably 115° C. to 150° C., even more preferably 120° C. to 150° C., and still even more preferably 125° C. to 140° C. If the melting point is excessively low, the foaming properties of the foam may be impaired, and conversely, if the melting point is excessively high, the productivity of the foam may be impaired.

In the present specification including claims, the glass transition temperature and the melting point can be measured using a differential scanning calorimeter (DSC), and specifically, can be measured by the method described in Examples described later.

The weight average molecular weight (Mw) of the 4-methyl-1-pentene based resin is, for example, 10,000 to 3,000,000, preferably 50,000 to 2,000,000, more preferably 100,000 to 1,000,000, even more preferably 200,000 to 500,000, and still even more preferably 300,000 to 400,000. If the molecular weight is excessively small, the mechanical properties of the foam may be impaired, and conversely, if the viscosity is excessively large, the molding processability may be impaired.

The molecular weight distribution (Mw/Mn) of the 4-methyl-1-pentene based resin is for example from 1 to 10, preferably from 1.2 to 5, more preferably from 1.3 to 3, and even more preferably from 1.5 to 2.5. If the molecular weight distribution is excessively small, the productivity of the polymer may be impaired, and conversely, if the molecular weight distribution is excessively large, the foaming properties and the mechanical properties may be impaired.

In the present specification including claims, the weight average molecular weight and the molecular weight distribution can be measured in terms of polystyrene using a gel permeation chromatograph, and specifically, can be measured by the method described in examples described later.

A density of the 4-methyl-1-pentene based resin is for example from 300 to 2,000 kg/m³, preferably from 500 to 1500 kg/m³, more preferably from 600 to 1200 kg/m³, even more preferably from 700 to 1000 kg/m³, and still even more preferably 800 to 900 kg/m³. If the density is excessively small, the mechanical properties may be impaired, and conversely, if the density is excessively large, the foaming properties may be impaired.

Note that in the present specification including claims, the density can be measured by a method according to JIS K6268, and more specifically, can be measured by a method described in the examples below.

For the dynamic viscoelasticity of the 4-methyl-1-pentene based resin, a peak value of a loss tangent (tan 6) may be approximately from 0.1 to 10, for example, from 0.2 to 8, preferably from 0.3 to 5, more preferably from 0.5 to 4, even more preferably from 1 to 3, and still even more preferably from 1.5 to 2.5. The peak temperature of the tan 6 may be approximately 0° C. to 60° C., and the peak temperature is preferably 10° C. to 55° C., more preferably 20° C. to 50° C., even more preferably 25° C. to 45° C., and still even more preferably 30° C. to 40° C. from the viewpoint of improving stress relaxation at a temperature near body temperature of the human body.

Note that, in the present specification including the claims, the dynamic viscoelasticity is determined by measuring the loss tangent from −40° C. to 150° C. at a frequency of 10 rad/s. Specifically, the dynamic viscoelasticity can be determined by the method described in the examples described below.

The 4-methyl-1-pentene based resin may be used to adjust the properties of the foam by combining multiple kinds of polymers having different thermal properties, molecular weight, density, and dynamic viscoelasticity. For example, a 4-methyl-1-pentene based resin having a melting point (first 4-methyl-1-pentene based resin) and a 4-methyl-1-pentene based resin that does not have a melting point (second 4-methyl-1-pentene based resin) can be combined to achieve both foaming properties and stress relaxation.

The mass ratio of the first 4-methyl-1-pentene based resin and the second 4-methyl-1-pentene based resin is former/latter=approximately from 90/10 to 10/90, preferably from 80/20 to 20/80, more preferably from 70/30 to 30/70, and even more preferably from 60/40 to 40/60.

As the first 4-methyl-1-pentene based resin, a polymer may be used where the peak value of tan δ is, for example, from 0.5 to 2.8, preferably from 1 to 2.5, more preferably from 1.2 to 2, and even more preferably from 1.3 to 1.8. As the second 4-methyl-1-pentene based resin, a polymer may be used where the peak value of tan δ is, for example, from 1.5 to 5, preferably from 2 to 4, more preferably from 2.5 to 3.5, and even more preferably from 2.6 to 3.

The 4-methyl-1-pentene based resin can be produced by a known method using an olefin polymerization catalyst, and can be produced by, for example, the methods disclosed in Patent Documents 1 and 2.

### [Foaming Agent]

The 4-methyl-1-pentene based resin foam according to embodiments of the present disclosure is obtained by foaming a foamable resin composition containing the 4-methyl-1-pentene based resin, and the foaming resin composition may contain a foaming agent.

The foaming agent may be a common foaming agent, which may be a degradable foaming agent (chemical foaming agent), but a volatile foaming agent (physical foaming agent) is preferable from the viewpoint of improving the expansion ratio in a simple manner. Examples of the volatile foaming agent include inorganic foaming agents (nitrogen, carbon dioxide, oxygen, air, water, and the like) and organic foaming agents (aliphatic hydrocarbons, cycloaliphatic hydrocarbons, aromatic hydrocarbons, chlorinated hydrocarbons, fluorinated hydrocarbons, alcohols, ethers, aldehydes, ketones, and the like). Among them, lower aliphatic hydrocarbons such as butane (n-butane, isobutane) and pentane (n-pentane, isopentane, and the like) are widely used from the viewpoint of being inexpensive and having low toxicity.

The proportion of the foaming agent is from 0.01 to 30 parts by mass, preferably from 0.1 to 25 parts by mass, more preferably 1 to 20 parts by mass, and even more preferably from 5 to 15 parts by mass per 100 parts by mass of 4-methyl-1-pentene based resin.

### [Foaming Nucleating Agent]

The 4-methyl-1-pentene based resin foam according to embodiments of the present disclosure may further contain a foaming nucleating agent. Examples of the foaming nucleating agent include silicon compounds (talc, silica, zeolite, and the like), inorganic acid salts (sodium bicarbonate, calcium carbonate, magnesium carbonate, sodium hydrogen carbonate, ammonium carbonate, and the like), organic acid or salt thereof (citric acid, sodium citrate, calcium stearate, aluminum stearate, zinc stearate, and the like), metal oxides (zinc oxide, titanium oxide, aluminum oxide, and the like), and metal hydroxides (aluminum hydroxide and the like). These foaming nucleating agents can be used alone or in combination of two or more thereof.

The proportion of the foaming nucleating agent is from 0.01 to 10 parts by mass, preferably from 0.05 to 5 parts by mass, more preferably from 0.1 to 3 parts by mass, and even more preferably from 0.5 to 2 parts by mass per 100 parts by mass of 4-methyl-1-pentene based resin.

### [Anti-Shrinkage Agent]

The 4-methyl-1-pentene based resin foam according to embodiments of the present disclosure may further contain an anti-shrinkage agent. Examples of the anti-shrinkage agent include fatty acid esters (esters of C₈₋₂₄ fatty acids such as palmitic acid mono-triglyceride, stearic acid mono-triglyceride, and polyhydric alcohols, and the like), and fatty acid amides (C₈₋₂₄ fatty acid amides such as palmitic acid amides and stearic acid amides, and the like). These anti-shrinkage agents can be used alone or in combination of two or more thereof.

The proportion of the ratio of the anti-shrinkage agent is from 0.01 to 30 parts by mass, preferably from 0.05 to 20 parts by mass, more preferably from 0.1 to 10 parts by mass, and even more preferably from 1 to 5 parts by mass per 100 parts by mass of 4-methyl-1-pentene based resin.

### [Other Thermoplastic Resin]

As a thermoplastic resin, the 4-methyl-1-pentene based resin foam according to embodiments of the present disclosure may further contain a thermoplastic resin (another thermoplastic resin) other than the 4-methyl-1-pentene based resin.

Examples of other thermoplastic resins include an olefin-based resin (another olefin-based resin) other than 4-methyl-1-pentene based resin, a styrene-based resin, a vinyl chloride-based resin, a vinyl acetate-based resin, a polyvinyl alcohol-based resin, an acrylic-based resin, a polyacetal-based resin, a polyester-based resin, a polycarbonate resin, a polyamide-based resin, and a thermoplastic elastomer containing the components of these resins. These thermoplastic resins can be used alone or in combination of two or more thereof.

Among these, other olefin-based resins, a styrene-based resin, a thermoplastic elastomer (for example, an olefin-based thermoplastic elastomers other than a 4-methyl-1-pentene based resin, a styrene-based thermoplastic elastomers, and the like) are preferable, and from the viewpoint of excellent compatibility with 4-methyl-1-pentene based resin, mechanical properties such as flexibility and elasticity, other olefin-based resins, (particularly polyethylene resins such as polyethylene or ethylene-propylene copolymers) and an olefin-based thermoplastic elastomers other than a 4-methyl-1-pentene based resin are preferable.

The mass ratio of the 4-methyl-1-pentene based resin to the other thermoplastic resins can be selected from a range of approximately 4-methyl-1-pentene based resin/other thermoplastic resins=from 100/0 to 10/90 (for example, from 100/0 to 50/50), and in a case where both resins are combined, 4-methyl-1-pentene based resin/other thermoplastic resin=from 99/1 to 30/70, preferably from 98/2 to 50/50, more preferably from 95/5 to 70/30, and still more preferably from 93/7 to 80/20. The thermoplastic resin is most preferably a 4-methyl-1-pentene based resin alone. If the proportion of the 4-methyl-1-pentene based resin is excessively low, the stress relaxation and vibration resistance may be impaired.

### [Other Additives]

The 4-methyl-1-pentene based resin foam according to embodiments of the present disclosure may further contain other known additives. Examples of such known additives include colorants (such as dyes or pigments, and the like), surface smoothing agents, air bubble regulators, stabilizers (antioxidants, thermal stabilizers, UV absorbers, and the like), viscosity modifiers, compatibilizers, dispersants, antistatic agents, anti-blocking agents, anti-fog agents, fillers (calcium carbonate, carbon fibers, and the like), lubricants, release agents, lubricants, impact modifiers, plasticizers, flame retardants, bioside (bactericides, bacteriostats, antifungals, preservatives, insect repellants, and the like), and deodorants. These additives can be used alone or in combination of two or more thereof.

The proportion of those other additives is from 0.01 to 30 parts by mass, preferably from 0.05 to 20 parts by mass, more preferably from 0.1 to 10 parts by mass, and even more preferably from 1 to 5 parts by mass per 100 parts by mass of 4-methyl-1-pentene based resin.

[Properties of 4-methyl-1-pentene Based Resin Foam]

The 4-methyl-1-pentene based resin foam according to embodiments of the present disclosure can improve the foaming properties despite the fact that the main component of the thermoplastic resin is a 4-methyl-1-pentene based resin that is difficult to improve the foaming properties. The specific expansion ratio may be 3 times or greater (in particular, 10 times or greater), for example 3 to 80 times, preferably from 5 to 70 times, more preferably from 10 to 60 times, even more preferably from 20 to 50 times, and even still more preferably from 30 to 40 times. If the expansion ratio is too low, the stress relaxation may be impaired.

The 4-methyl-1-pentene based resin foam according to embodiments of the present disclosure has a closed cell structure and/or an open cell structure, and preferably contains at least a closed cell structure. A closed cell ration, which is a proportion of the closed cells with respect to the total air bubbles (total of open cells and closed cells) may be 50% by volume, for example, from 85% to 100% by volume, preferably from 90% to 100% by volume (for example, from 90% to 99% by volume), more preferably from 93% to 100% by volume (for example, from 93% to 99% by volume), and even more preferably 100% by volume. If the closed cell ration is excessively low, the mechanical properties of the foam may be impaired.

An average cell diameter of the 4-methyl-1-pentene based resin foam according to embodiments of the present disclosure is, for example, from 0.2 to 2 mm, preferably from 0.3 to 1.8 mm, more preferably from 0.4 to 1.5 mm, and even more preferably from 0.5 to 1.2 mm. If the average cell diameter is excessively small, it may be difficult to increase the expansion ratio, and if the average bubble size is excessively large, the mechanical properties may be impaired

The 4-methyl-1-pentene based resin foam according to embodiments of the present disclosure preferably has a skin layer on a surface, and the coverage of the skin layer with respect to the entire surface may be 60% by area or greater (in particular 80% by area or greater), and may be preferably 90% by area or greater, and 100% by area (skin layer on the entire surface). The skin layer means a non-foaming layer that extends at a substantially uniform thickness on the surface of the 4-methyl-1-pentene based resin foam.

An average thickness of the skin layer can be selected from a range of approximately 0.001 to 1 mm, and is, for example, from 0.005 to 0.1 mm, preferably from 0.008 to 0.05 mm, more preferably from 0.01 to 0.03 mm, and even more preferably from 0.012 to 0.025 mm. If the average thickness of the skin layer is excessively thin, the handleability may be impaired, and conversely, if the average thickness is excessively thick, the foaming properties may be impaired.

In the present specification including claims, the expansion ratio, the open cell ratio (closed cell ratio), the average cell diameter, and the average thickness of the skin layer can be measured by the methods described in examples described later.

[Method of Producing 4-methyl-1-pentene Resin Foam]

A method for producing a 4-methyl-1-pentene based resin foam according to embodiments of the present disclosure may be a method for foam-molding a foamable resin composition containing the 4-methyl-1-pentene based resin, and a known method can be used, which is typically a method of melt-kneading to foam molding the resin composition.

The melt-kneading may be melt-kneading using a known melt kneader, such as a single shaft or a vented twin screw extruder. Furthermore, prior to the melt-kneading, the 4-methyl-1-pentene based resin and other components (a foaming agent and, as necessary, a foaming nucleating agent, an additive, or the like) may be premixed using a known method, for example, a mixer (tumbler, V blender, Henschel mixer, Nauta mixer, ribbon mixer, mechanochemical equipment, extrusion mixer, and the like).

Known methods such as an extrusion molding method (for example, a T-die method, an inflation method, and the like), an injection molding method, and the like can be used as a foam molding method. Among these, an extrusion molding method is preferable from the viewpoint of producing foams having high foaming properties with high productivity.

In the extrusion molding method, for example, a single screw extruder (for example, a vented extruder or the like), a twin screw extruder (for example, a co-axial twin screw extruder, an anisotropic twin screw extruder, or the like), and a multi-stage extruder such as a tandem extruder is preferable from the viewpoint that the foaming conditions can be easily adjusted and high foaming rate can be realized.

In the extrusion molding method, the method for introducing the foaming agent is not limited, and the degradable foaming agent (chemical foaming agent) may be pre-blended in the foamable resin composition, but from the viewpoint of improving the expansion ratio in a simple manner, it is preferable to introduce a volatile foaming agent (physical foaming agent) in the extruder.

The shape of a die outlet (die lip) is not limited, and can be selected according to the intended form. For example, the shape may be a one-dimensional shape such as a rod shape or a string shape, a two-dimensional shape such as a sheet shape, a film shape, or a two-dimensional mesh (net) shape, and a three-dimensional shape such as a block shape, a plate shape, a columnar shape, a slit shape, an L shape, a U shape, a pipe shape, or a ring shape.

The foam molding temperature is formed at a temperature higher than the glass transition temperature (Tg) of the 4-methyl-1-pentene based resin, such as (Tg+10)° C. to (Tg+100° C.), preferably (Tg+30)° C. to (Tg+90)° C., more preferably (Tg+40)° C. to (Tg+80)° C., even more preferably (Tg+45)° C. to (Tg+75)° C., still even more preferably (Tg+50)° C. to (Tg+70)° C. Also, the foam molding temperature of the 4-methyl-1-pentene based resin having a melting point is formed at a temperature lower than the melting point (Tm) of the 4-methyl-1-pentene based resin, for example (Tm−60)° C. to (Tm−5)° C., preferably (Tm−50)° C. to (Tm−10)° C., and more preferably (Tm−40)° C. to (Tm−20)° C. In the present disclosure, foam molding can be performed at a relatively low temperature and the expansion ratio can be improved. If the foam molding temperature is excessively low, the productivity of the foam molded article may be impaired, and conversely, if the foam molding temperature is excessively high, the foaming properties may be impaired

The extruded foam may be cooled in a known manner, for example, by a cooling method using a cooler. In the cooling method using a cooler, a cooling medium includes a cooling medium such as compressed air, water (cooling water), and air (blower). Examples of the cooling method include a method for spraying compressed air, a method for cooling by a blower, a method for spraying water and cooling, and a method for cooling using a cooling jacket, and the like. The temperature of the cooling medium is, for example, 0° C. to 60° C., preferably 5° C. to 55° C., and still more preferably 10° C. to 50° C.

In the method for spraying the compressed air, the pressure of the air is, for example, from 0.1 to 10 MPa, preferably from 0.2 to 5 MPa, and more preferably from 0.3 to 1 MPa. An injection amount of the compressed air is, for example, from 100 to 1000 liters/minute, preferably from 200 to 500 liters/minute, and more preferably from 250 to 400 liters/minute.

Furthermore, if necessary, the obtained 4-methyl-1-pentene based resin foam (in particular, a sheet-like foam) may be subjected to secondary processing [for example, vacuum forming, pressure forming, vacuum pressure molding, matching mold molding, or the like (for example, thermoforming using a mold).

Note that the secondary processing or molding temperature may be, for example, approximately 70° C. to 300° C., preferably 80° C. to 280° C., and more preferably approximately 85° C. to 260° C.

The shape of the foam can be selected as appropriate for any shape depending on the application, and may be, for example, a rod shape, a sheet shape, a net shape, a pipe shape, a three-dimensional shape, or the like.

Each aspect disclosed in the present specification can be combined with any other feature disclosed herein.

### EXAMPLES

Hereinafter, the present disclosure is described in greater detail based on examples, but the present disclosure is not limited to these examples. The properties of the obtained foam were evaluated by the following method.

[4-methyl-1-pentene and Propylene Contents in Polymer]

A polymer was obtained under the conditions of an orthodichlorobenzene/heavy benzene (80/20% by volume) mixed solvent used as a solvent, sample concentration of 55 mg/0.6 ml, measurement temperature of 120° C., observation nucleus of ¹³C (125 MHz), a sequence of single pulse proton decoupling, pulse width of 4.7 μsec (45° pulse), repeat time of 5.5 seconds, accumulation number of 10,000 times or more, and chemical shift of 27.50 ppm as a reference value, and then ¹³C-NMR spectra of the obtained polymer was measured by using a nuclear magnetic resonance apparatus (“ECP500 type” manufactured by JEOL Ltd.). The obtained ¹³C-NMR spectra quantified the composition of 4-methyl-1-pentene and propylene in the polymer.

### [Weight Average Molecular Weight (Mw), Molecular Weight Distribution (Mw/Mn) of Polymer]

The weight average molecular weight (Mw) and molecular weight distribution (Mw/Mn) of the obtained polymer were measured as follows using a gel permeation chromatograph Alliance GPC-2000 type manufactured by Waters.

A separation column had two TSKgel GNH6-HT and two TSKgel GNH6-HTL, both of which have a diameter of 7.5 mm and a length of 300 mm, the column temperature was 140° C., as a mobile phase, 0.025% by mass of BHT (dibutylhydroxytoluene) was used as o-dichlorobenzene and antioxidants and the mixture was moved at 1.0 ml/minute, the sample concentration was 15 mg/10 ml, the sample injection volume was 500 microliters, and a differential refractometer was used as a detector. As the standard polystyrene, polystyrene produced by Pressure Chemical Corporation was used.

### [Glass Transition Temperature (Tg) and Melting Point (Tm) of Polymer]

The glass transition temperature (Tg) and the melting point (Tm) of the obtained polymer were measured in such a manner that using a DSC measurement device (“DSC220C” available from Seiko Instruments Inc.), a measuring aluminum pan was filled with about 5 mg of a sample, and the temperature was raised to 250° C. at 10° C./minute under a nitrogen atmosphere, held at 250° C. for 5 minutes, lowered to −50° C. at 10° C./minute, and then raised to 250° C. at 10° C./minute, and from the graph at this time, the glass transition temperature (Tg) was calculated, and the melting point (Tm) was calculated from a peak apex of a crystal melting peak. In a case of the polymer having multiple peaks, the apex of the peak located at the highest temperature side was defined as the melting point (Tm).

### [Intrinsic Viscosity of Polymer]

The intrinsic viscosity [η] dissolved approximately 20 mg of the polymer in 15 ml of decalin, and the specific viscosity ηsp was measured in an oil bath at 135° C. 5 ml of decalin solvent was added to the decalin solution, and after dilution, the specific viscosity ηsp was measured in the same manner. This dilution operation was repeated two more times, and as shown in Equation (1) below, a value of ηsp/C when a concentration (C) was extrapolated to 0 was determined as the intrinsic viscosity.

[η]=lim(ηsp/C)(C→0) (1)

### [Density of Polymer]

The obtained polymer was sheet-molded at a gauge pressure of 10 MPa using a hydraulic heat press machine (“NS-50” available from Sinto Metal Industries, Ltd.) set at 200° C. to 260° C. The obtained 1 mm thick press sheet was cut into 30 mm squares and measured by an underwater substitution method using an electronic hydrometer in accordance with JIS K6268.

### [Dynamic Viscoelasticity of Polymer]

A 3 mm thick press sheet obtained by the same method as the density measurement was cut into 45 mm×10 mm, and by using a dynamic viscoelasticity measuring device (“MCR301” available from Anton Paar), the temperature dependence of dynamic viscoelasticity from −40° C. to 150° C. was measured at a frequency of 10 rad/s, and the tan δ peak value and peak temperature were determined.

### [Basis Weight of Foam]

A foam was cut at 1 m and measured using an electronic hydrometer (“MD200S” available from Alfa Mirage Co., Ltd.) (n=3).

### [Expansion Ratio of Foam]

The expansion ratio was calculated based on the following equation.

Expansion ratio (x)=density of resin composition for foam/apparent density of foam.

### [Open Cell Ratio of Foam]

The obtained foam was measured in advance by weighing, and after being left to stand in water, the foam was left to stand for 1 minute under reduced pressure of −400 mmHg, and water was permeated into an open cell structure. The pressure was returned from the reduced pressure state to atmospheric pressure, and after the water attached to the surface of the foam was removed and the weight was measured, the pressure was calculated according to Equation (2) below.

Open cell ratio (%)={(w₂−w₁)/d₃}/(w₁/d₁−w₁/d₂)×100 (2),

(where w₂ represents a foam weight after absorbing water, w₁ represents a foam weight before absorbing water; d₁ represents an apparent density of the foam, d₂ represents an apparent density of a resin composition used in the foam (density of resin composition for foam), and d₃ represents a density of water at the time of measurement).

### [Cell Diameter (Cell Size) of Foam]

A cross section of the obtained foam was observed using a scanning electron microscope or digital microscope (available from Scala, Inc.), and the cell diameter in a TD direction and a MD direction was measured at any of 10 locations, and an average value was taken as a cell diameter. Furthermore, each of the cell diameters was an average value of a long diameter and a short diameter.

### [Average Thickness of Skin Layer of Foam]

The thickness of the skin layer in the TD direction was measured at any of 10 locations using an electron microscope (available from Scala, Inc.) and filing & two-dimensional measurement software (“AR-CNVMF” available from ARTRAY CO., LTD), and an average value was taken as an average thickness of the skin layers.

### [Compression Hardness of Foam]

The measurement was performed in accordance with JIS K 6767-1999 using a tensile tester (available from Shimadzu Corporation). The test conditions are as follows: load: 102 kgf (1 kN), indenter: 100.2 mm, speed: 10 mm/min, and temperature: 15° C., 20° C., and 25° C. The methods for measuring the evaluation items were as follows.

(1) A sample is cut and set in a testing machine (Test piece: overlaid so as to be 50 mm square and 25 mm in height),

(2) an upper (UPPER) is lowered to a sample contact surface, and a 3 N load is applied after setting the test force to 0 to measure a height (thickness),

(3) the sample is compressed to 25% of the height measured in (2) at a test speed of 10 mm/min and maintained for 20 seconds (a peak value at this time is taken as the maximum load), and

(4) the compression hardness (N/cm²) is determined.

### Example 1

### (Production of First 4-Methyl-1-Pentene Based Resin)

300 ml of normal hexane and 450 ml of 4-methyl-1-pentene were charged at 23° C. in a nitrogen-purged SUS autoclave with a stirring blade having a volume of 1.5 liters. The autoclave was charged with 0.75 ml of a 1 mmol/ml toluene solution of triisobutylaluminum, and the stirrer was turned. Next, the autoclave was heated to an internal temperature of 60° C., and pressurized with propylene so that the total pressure was 0.19 MPa (gauge pressure). Subsequently, 0.34 ml of a toluene solution containing 1 mmol of methylaluminoxane in terms of Al and 0.01 mmol of diphenylmethylene (1-ethyl-3-t-butyl-cyclopentadienyl) (2,7-di-t-butyl-fluorenyl) zirconium dichloride was press-fitted into an autoclave with nitrogen to start polymerization. During the polymerization reaction, the temperature was adjusted so that the internal autoclave temperature was 60° C. After 60 minutes of polymerization, 5 ml of methanol was pressed into the autoclave with nitrogen, the polymerization was stopped, and the autoclave was depressurized to atmospheric pressure. The reaction solution was poured with acetone while stirring. The obtained powdery polymer containing a solvent was dried at 100° C. under reduced pressure for 12 hours. As a result of measuring physical properties of the obtained polymer, the following were obtained.

4-methyl-1-pentene content: 84.1 mol %

Propylene content: 15.9 mol %

Weight average molecular weight (Mw): 340,000

Molecular weight distribution (Mw/Mn): 2.1

Glass transition temperature (Tg): 40° C.

Melting point (Tm): 132° C.

Intrinsic viscosity [ii]: 1.5 dl/g

Density: 838 kg/m³

Tan δ peak value: 1.6

Temperature at tan δ peak: 39° C.

### (Production of Foam)

100 parts by mass of a first 4-methyl-1-pentene based resin, 1.7 parts by mass of talc (“MICRO ACE K-1” available from Nippon Talc Co., Ltd., average particle diameter 7.4 μm) as a foaming nucleating agent, and 3.0 parts by mass of an anti-shrinkage agent (“ACTIVEX 325” manufactured by Boehringer Ingelheim Chemicals, Inc.) were supplied to a tandem extruder (available from Pla Giken Co., Ltd., screw diameter: 90 mm, L/D=35), and melt-kneaded under the conditions of a temperature of 100° C. (temperature in a head immediately after an extruder outlet) and a pressure of 12 MPa, and 8.0 parts by mass of isobutane gas was injected from the middle of the extruder, then cooled to an appropriate foaming temperature, and extruded and foamed from a die of a mold (ring die) attached to the tip so as to obtain a net-shaped foam. The obtained foam had, as shown in Table 1, a tubular shape with a width of 423 mm and a thickness (thickness W in the table) of 19.4 mm, and had a basis weight of 92.4 g/m, an expansion ratio of 27.5 times, a mesh pitch of the net-shaped foam of 98 mm, a thickness of the net-shaped foam (thickness S in the table) of 9.9 mm, an open cell ratio of 1.7% by volume, a cell diameter of 0.46 mm, and an average thickness of the skin layer of 0.017 mm.

### Examples 2 to 4

A net-shaped foam was produced in the same manner as in Example 1 with the exception that the basis weight and shape were changed as shown in Table 1.

The evaluation results of the net-like foams obtained in Example 1 to 4 are shown in Tables 1 and 2.

TABLE 1

| | Basis | Expansion | | | Thickness | Thickness | Open cell | Cell | Skin layer |
|---|---|---|---|---|---|---|---|---|---|
| | weight | ratio | Width | Pitch | S | W | ratio | diameter | thickness |
| | (g/m) | (times) | (mm) | (mm) | (mm) | (mm) | (%) | (mm) | (mm) |
| Example 1 | 92.4 | 27.5 | 423 | 98 | 9.9 | 19.4 | 1.70 | 0.46 | 0.017 |
| Example 2 | 118.4 | 25.8 | 355 | 50 | 11.7 | 23.1 | 1.84 | 0.47 | 0.016 |
| Example 3 | 253.8 | 30.0 | 305 | 42 | 23.1 | 44.0 | 1.17 | 0.90 | 0.018 |
| Example 4 | 134.8 | 34.3 | 220 | 40 | 14.3 | 26.4 | 2.52 | 0.57 | 0.015 |

TABLE 2

| | 15° C. | | 20° C. | | 25° C. | |
|---|---|---|---|---|---|---|
| | Maximum | Compression | Maximum | Compression | Maximum | Compression |
| | load | hardness | load | hardness | load | hardness |
| | (N) | (N/cm²) | (N) | (N/cm²) | (N) | (N/cm²) |
| Example 1 | 19.95 | 0.79 | 14.70 | 0.57 | 12.08 | 0.47 |
| Example 2 | 34.98 | 1.38 | 23.25 | 0.92 | 19.84 | 0.78 |
| Example 3 | 105.17 | 4.18 | 65.24 | 2.56 | 47.88 | 1.84 |
| Example 4 | 143.65 | 5.66 | 93.83 | 3.58 | 87.03 | 3.34 |

The foams obtained in Example 1 to 4 had a high expansion ratio and reduced compression hardness as temperature increased and approached body temperature.

### Example 5

(Second 4-methyl-1-pentene based resin)

A powdery polymer was obtained by drying in the same manner as in the production of the first polymer except that the total pressure of propylene to be pressurized was changed from 0.19 MPa to 0.4 MPa. As a result of measuring physical properties of the obtained polymer, the following results were obtained.

4-methyl-1-pentene content: 72.5 mol %

Propylene content: 27.5 mol %

Weight average molecular weight (Mw): 337,000

Molecular weight distribution (Mw/Mn): 2.1

Glass transition temperature (Tg): 30° C.

Melting point (Tm): None

Intrinsic viscosity [η]: 1.5 dl/g

Density: 839 kg/m³

Tan δ peak value: 2.8

Temperature at tan δ peak: 31° C.

### (Production of Foam)

A net-shaped foam was obtained in the same manner as in Example 1 except that the second 4-methyl-1-pentene based resin was used instead of the first 4-methyl-1-pentene based resin. The expansion ratio of the foam before curing was 20 times.

### Examples 6 to 9

A net-shaped foam was produced in the same manner as in Example 1 except that 46 parts by mass of the first 4-methyl-1-pentene based resin and 54 parts by mass of the second 4-methyl-1-pentene based resin were used instead of 100 parts by mass of the first 4-methyl-1-pentene based resin. The properties of the obtained net-shaped foams are shown in Table 3 and the evaluation results are shown in Table 4.

TABLE 3

| | Basis | Expansion | | | Thickness | Thickness | Open cell | Cell | Skin layer |
|---|---|---|---|---|---|---|---|---|---|
| | weight | ratio | Width | Pitch | S | W | ratio | diameter | thickness |
| | (g/m) | (times) | (mm) | (mm) | (mm) | (mm) | (%) | (mm) | (mm) |
| Example 6 | 115 | 16.3 | 285 | 50 | 10.0 | 20.0 | 4.36 | 0.96 | 0.018 |
| Example 7 | 119.2 | 21.8 | 307 | 55 | 10.2 | 20.4 | 1.61 | 1.06 | 0.017 |
| Example 8 | 80.4 | 20.2 | 300 | 52 | 10.4 | 20.8 | 3.18 | 1.11 | 0.017 |
| Example 9 | 113.8 | 19.1 | 291 | 49 | 10.1 | 20.2 | 3.05 | 0.96 | 0.019 |

TABLE 4

| | 15° C. | | 20° C. | | 25° C. | |
|---|---|---|---|---|---|---|
| | Maximum | Compression | Maximum | Compression | Maximum | Compression |
| | load | hardness | load | hardness | load | hardness |
| | (N) | (N/cm²) | (N) | (N/cm²) | (N) | (N/cm²) |
| Example 6 | 163.62 | 6.40 | 115.91 | 4.49 | 57.59 | 2.22 |
| Example 7 | 37.20 | 1.45 | 24.41 | 0.93 | 14.13 | 0.54 |
| Example 8 | 129.54 | 5.09 | 95.37 | 3.68 | 57.86 | 2.25 |
| Example 9 | 120.46 | 4.75 | 89.3 | 3.51 | 56.54 | 2.21 |

The net-shaped foams obtained in Examples 6 to 9 had a high expansion ratio and reduced compression hardness as temperature increased and approached body temperature.

### Examples 10 to 12

46 parts by mass of a first 4-methyl-1-pentene based resin, 54 parts by mass of the second 4-methyl-1-pentene based resin, 1.7 parts by mass of talc “MICRO ACE K-1” manufactured by Nippon Talc Co., Ltd., average particle diameter 7.4 μm, as a foaming nucleating agent, and 3.0 parts by mass of an anti-shrinkage agent (ACTIVEX 325) were supplied to a tandem extruder (available from Pla Giken Co., Ltd., screw diameter: 90 mm, L/D=35), and melt-kneaded under the conditions of a temperature of 100° C. (temperature in a head immediately after an extruder outlet) and a pressure of 11.0 MPa, and 7.0 parts by mass of isobutane gas was injected from the middle of the extruder, then cooled to an appropriate foaming temperature, and extruded from a ring-shaped die attached to a tip so as to obtain a sheet-shaped foam. The obtained foam had a tubular shape with a width of 85 mm and a thickness of 4.8 mm, and had a basis weight of 52 g/m, an expansion ratio of 12 times, an open cell ratio of 2.25%, a cell size (cell diameter) of 1.36 mm, and an average thickness of the skin layer of 0.019 mm. The properties of the foams obtained in Examples 10 to 12 are shown in Table 5 and the evaluation results are shown in Table 6.

TABLE 5

| | Basis | Expansion | | | Open cell | Cell | Skin layer |
|---|---|---|---|---|---|---|---|
| | weight | ratio | Width | Thickness | ratio | diameter | thickness |
| | (g/m) | (times) | (mm) | (mm) | (%) | (mm) | (mm) |
| Example 10 | 52.0 | 12.0 | 85 | 4.8 | 2.25 | 1.36 | 0.019 |
| Example 11 | 52.6 | 17.7 | 113 | 4.9 | 2.10 | 1.29 | 0.018 |
| Example 12 | 52.4 | 20.7 | 110 | 6.0 | 1.60 | 1.78 | 0.016 |

TABLE 6

| | 15° C. | | 20° C. | | 25° C. | |
|---|---|---|---|---|---|---|
| | Maximum | Compression | Maximum | Compression | Maximum | Compression |
| | load | hardness | load | hardness | load | hardness |
| | (N) | (N/cm²) | (N) | (N/cm²) | (N) | (N/cm²) |
| Example 10 | 194.45 | 7.09 | 158.98 | 5.86 | 123.75 | 4.47 |
| Example 11 | 117.48 | 4.46 | 123.63 | 4.70 | 113.34 | 4.25 |
| Example 12 | 130.64 | 4.90 | 119.34 | 4.57 | 95.34 | 3.67 |

The sheet-shaped foams obtained in Examples 10 to 12 had a high expansion ratio and reduced compression hardness as temperature increased and approached body temperature.

### INDUSTRIAL APPLICABILITY

The 4-methyl-1-pentene based resin foam according to embodiments of the present disclosure can be used for health products, nursing care products (for example, falling prevention film/mat sheet, pressure ulcer prevention, and the like), medical products (for example, attachments such as prosthetic legs), shock-absorbing pads, protectors and protective gears (for example, helmets, guards, and the like), sports products (for example, a grip for sports and the like), sports gears, rackets, balls, bicycle products (for example, saddle cushion, baby seat, and the like), transportation tools (for example, a transport shock-absorbing grip, an shock-absorbing sheet, and the like), health appliances, industrial materials (for example, a damping pallet, a shock-absorbing damper, a shock-absorbing member for footwear, a shock-absorbing foam, a shock-absorbing film sheet, and the like), automobile shock-absorbing members (for example, a bumper shock-absorbing member, a cushion member, or the like), and the like.

1. A 4-methyl-1-pentene based resin foam comprising a 4-methyl-1-pentene based resin, and having an expansion ratio of 3 times or more.

2. The 4-methyl-1-pentene based resin foam according to claim 1,
wherein the 4-methyl-1-pentene based resin has an intrinsic viscosity [η] measured in a decalin solvent at 135° C. of 0.5 to 5 dl/g.

3. The 4-methyl-1-pentene based resin foam according to claim 1, wherein the 4-methyl-1-pentene based resin has a glass transition temperature of 0° C. to 80° C.

4. The 4-methyl-1-pentene based resin foam according to claim 1, wherein the 4-methyl-1-pentene based resin has a melting point.

5. The 4-methyl-1-pentene based resin foam according to claim 1, wherein the 4-methyl-1-pentene based resin is a 4-methyl-1-pentene-C₂₋₂₀α-olefin copolymer.

6. The 4-methyl-1-pentene based resin foam according to claim 1, wherein the 4-methyl-1-pentene based resin is a 4-methyl-1-pentene-C₂₋₄α-olefin copolymer.

7. The 4-methyl-1-pentene based resin foam according to claim 1, wherein the expansion ratio is 10 times or more.

8. A method for producing the 4-methyl-1-pentene based resin foam according to claim 1, comprising foam-molding a foamable resin composition containing the 4-methyl-1-pentene based resin.
